(19) United States
(12) Patent Application Publication
(10) Pub. No.: US 2023/0302546 A1
(43) Pub. Date: Sep. 28, 2023

(54) POSITIVE CLAMPING IN GROOVING TOOL HOLDERS

(71) Applicant: KENNAMETAL INDIA LIMITED, Bangalore (IN)

(72) Inventors: Yogesh Basavaraju, Bangalore (IN); IRANNA SHIDRAMESHETRA, BANGALORE (IN); Poornachander Rao Shanthamraju, Hyderabad (IN)

(21) Appl. No.: 18/178,506

(22) Filed: Mar. 5, 2023

(30) Foreign Application Priority Data
Mar. 23, 2022 (IN) 202241016060

(51) Int. Cl. B23B 29/04

(52) U.S. Cl. CPC B23B 29/043; B23B 2205/12

(57) ABSTRACT

A grooving tool holder includes a lower portion, an upper portion, a cutting insert receptacle, a first fastener-mating hole, a second fastener-mating hole, a first axis, and an upper portion. The upper portion is pivotable relative to the lower portion. The cutting insert receptacle is disposed between the lower portion and the upper portion. The cutting insert receptacle includes an upper clamping jaw disposed in the upper portion and a lower clamping jaw disposed in the lower portion. The first fastener-mating hole is disposed in the upper portion. The second fastener-mating hole is disposed in the lower portion in alignment with the first fastener-mating hole. The first axis extends longitudinally along the grooving tool holder through a center of the first fastener-mating hole. The upper portion includes differently shaped or sized first and second portions disposed on opposite sides of the first axis which are within +−20% of one another.

### FIELD OF THE DISCLOSURE

The disclosure relates to grooving tool holders and to methods of their use.

### BACKGROUND

Existing grooving tool holders often have issues applying uniform clamping pressure to a cutting insert held by the grooving tool holder. This can result in the cutting insert separating from the grooving tool holder. To avoid this, excessive amounts of tightening torque is often applied to clamp the cutting insert in place within the grooving tool holder. This can lead to damage to the grooving tool holder or cutting insert.

An improved grooving tool holder and method of its use is needed to reduce one or more issues associated with one or more of the existing grooving tool holders.

### SUMMARY

In one embodiment, a grooving tool holder includes a lower portion, an upper portion, a cutting insert receptacle, a first fastener-mating hole, a second fastener-mating hole, a first axis, and an upper portion. The upper portion is pivotable relative to the lower portion. The cutting insert receptacle is disposed between the lower portion and the upper portion. The cutting insert receptacle includes an upper clamping jaw disposed in the upper portion and a lower clamping jaw disposed in the lower portion. The first fastener-mating hole is disposed in the upper portion. The second fastener-mating hole is disposed in the lower portion in alignment with the first fastener-mating hole. The first axis extends longitudinally along the grooving tool holder through a center of the first fastener-mating hole. The upper portion includes first and second portions disposed on opposite sides of the first axis. The first and second portions include different shapes or different sizes. The upper portion includes a total mass. The first portion includes a first mass. The second portion includes a second mass. A sum of the first mass and the second mass equals the total mass of the upper portion. The first mass and the second mass are within +−20% of one another.

In another embodiment, a grooving tool holder includes a lower portion, an upper portion, a web portion, a cutting insert receptacle, a separating slit, a first fastener-mating hole, a second fastener mating-hole, a first axis, and an upper portion. The web portion is disposed between the lower portion and the upper portion. The cutting insert receptacle is disposed between the lower portion and the upper portion. The cutting insert receptacle includes an upper clamping jaw disposed in the upper portion and a lower clamping jaw disposed in the lower portion. The separating slit is disposed from the web portion to the cutting insert receptacle. The upper portion is pivotable relative to the lower portion via the web portion. The first fastener-mating hole is disposed in the upper portion. The second fastener-mating hole is disposed in the lower portion. The first axis extends longitudinally along the grooving tool holder through a center of the first fastener-mating hole. The first and second fastener-mating holes are concentrically aligned around a second axis. The first and second axis intersect perpendicularly. The upper portion includes first and second portions disposed on opposite sides of the first axis. The first and second portions include different shapes or different sizes. The upper portion includes a total mass. The first portion includes a first mass. The second portion includes a second mass. A sum of the first mass and the second mass equals the total mass of the upper portion. The first mass and the second mass are within +−20% of one another.

In still another embodiment, a method of attaching a cutting insert to a grooving tool holder is provided. In one step, the cutting insert is disposed into a cutting insert receptacle of the grooving tool holder between and against an upper clamping jaw of an upper portion of the grooving tool holder and a lower clamping jaw of a lower portion of the grooving tool holder. The upper portion comprises first and second portions disposed on opposite sides of a first axis extending longitudinally along the grooving tool holder through a center of the first fastener-mating hole. The first and second portions comprise different shapes or different sizes. The upper portion comprises a total mass. The first portion comprises a first mass. The second portion comprises a second mass. A sum of the first mass and the second mass equals the total mass of the upper portion. The first mass and the second mass are within +−20% of one another. In another step, a fastener is extended into a first fastener-mating hole in the upper portion into a second fastener-mating hole in the lower portion. In still another step, the fastener is moved in a first direction, the upper portion pivots relative to the lower portion, and the upper clamping jaw moves towards the cutting insert applying more clamping force against the cutting insert. In yet another step, the fastener is moved in a second direction, the upper portion pivots relative to the lower portion, and the upper clamping jaw moves away from the cutting insert applying less clamping force against the cutting insert.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a cutting insert of a grooving tool holder cutting a groove in a workpiece with the machine which moves the grooving tool holder removed;

FIG. 2 illustrates the perspective view of the grooving tool holder of FIG. 1 with the grooving tool holder attached to a machine which moves the grooving tool holder longitudinally;

FIG. 3 illustrates the perspective view of FIG. 2 with the grooving tool holder disassembled from the machine;

FIG. 4 illustrates the perspective view of the grooving tool holder of FIG. 1 with the workpiece removed;

FIG. 5 illustrates a left-side view of the grooving tool holder of FIG. 4;

FIG. 6 illustrates a front view of the grooving tool holder of FIG. 4;

FIG. 7 illustrates a top view of the grooving tool holder of FIG. 4;

FIG. 8 illustrates a partial right-side view of the grooving tool holder of FIG. 4;

FIG. 9 illustrates a partial perspective view of the grooving tool holder of FIG. 4 with the cutting insert disassembled from the grooving tool holder;

FIG. 10 illustrates a perspective view of another embodiment of a cutting insert of a grooving tool holder cutting a groove in a workpiece with the machine which moves the grooving tool holder removed;

FIG. 11 illustrates the perspective view of the grooving tool holder of FIG. 10 with the grooving tool holder attached to a machine which moves the grooving tool holder longitudinally;

FIG. 12 illustrates the perspective view of FIG. 11 with the grooving tool holder disassembled from the machine;

FIG. 13 illustrates the perspective view of the grooving tool holder of FIG. 10 with the workpiece removed;

FIG. 14 illustrates a left-side view of the grooving tool holder of FIG. 13;

FIG. 15 illustrates a front view of the grooving tool holder of FIG. 13;

FIG. 16 illustrates a top view of the grooving tool holder of FIG. 13;

FIG. 17 illustrates a partial right-side view of the grooving tool holder of FIG. 13;

FIG. 18 illustrates a partial perspective view of the grooving tool holder of FIG. 13 with the cutting insert disassembled from the grooving tool holder; and

FIG. 19 is a flowchart illustrating one embodiment of a method of attaching a cutting insert to a grooving tool holder.

### DETAILED DESCRIPTION

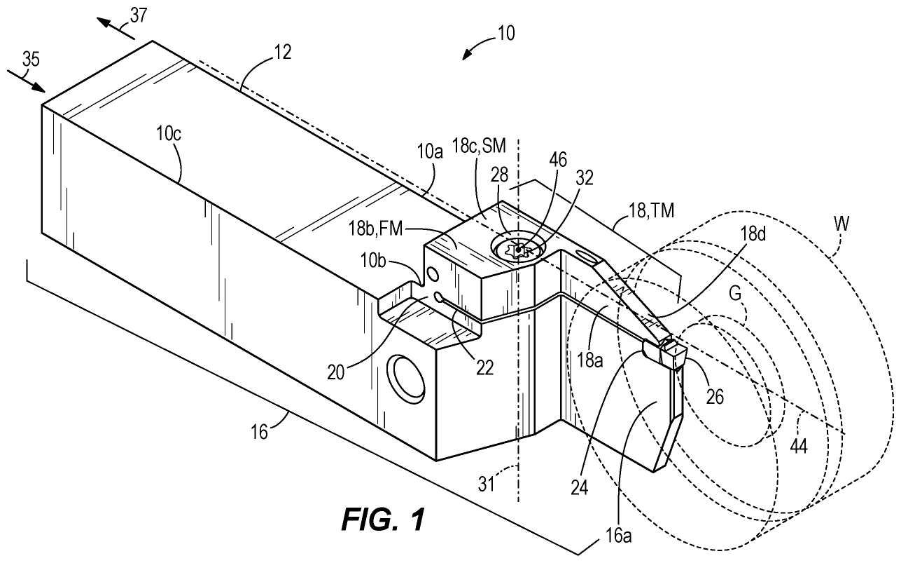

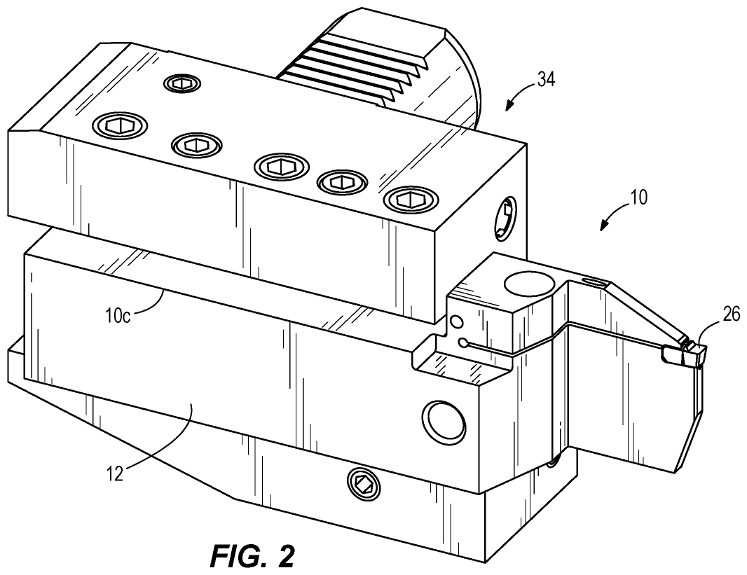

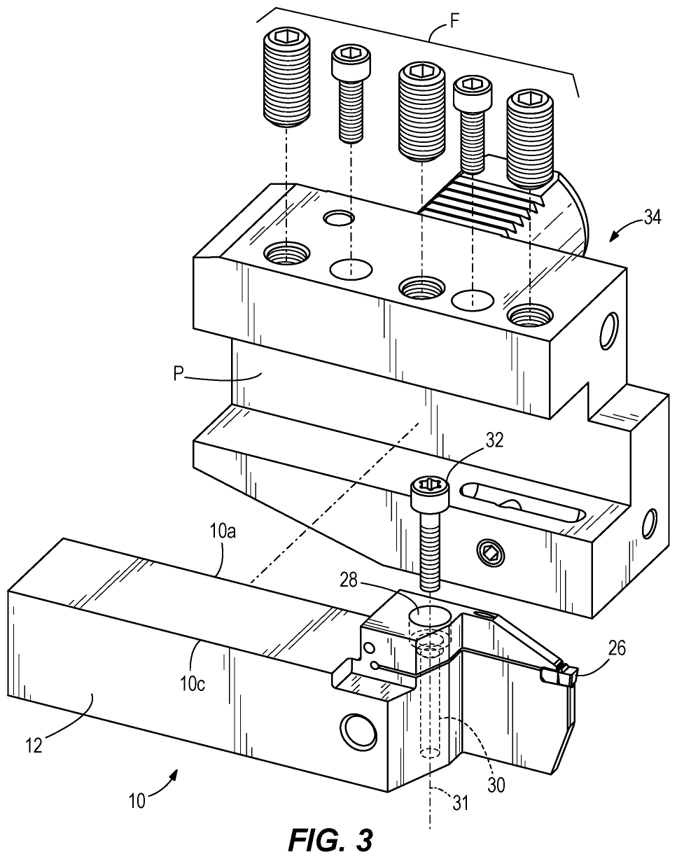

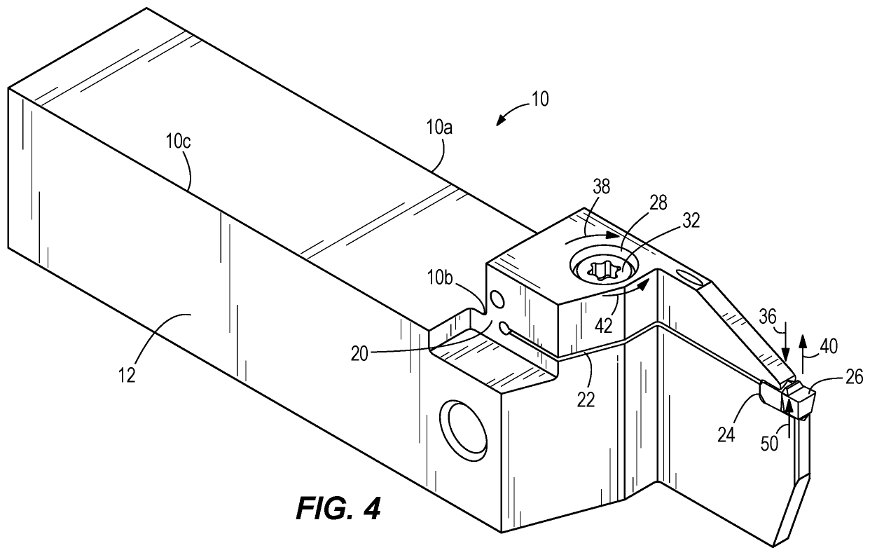

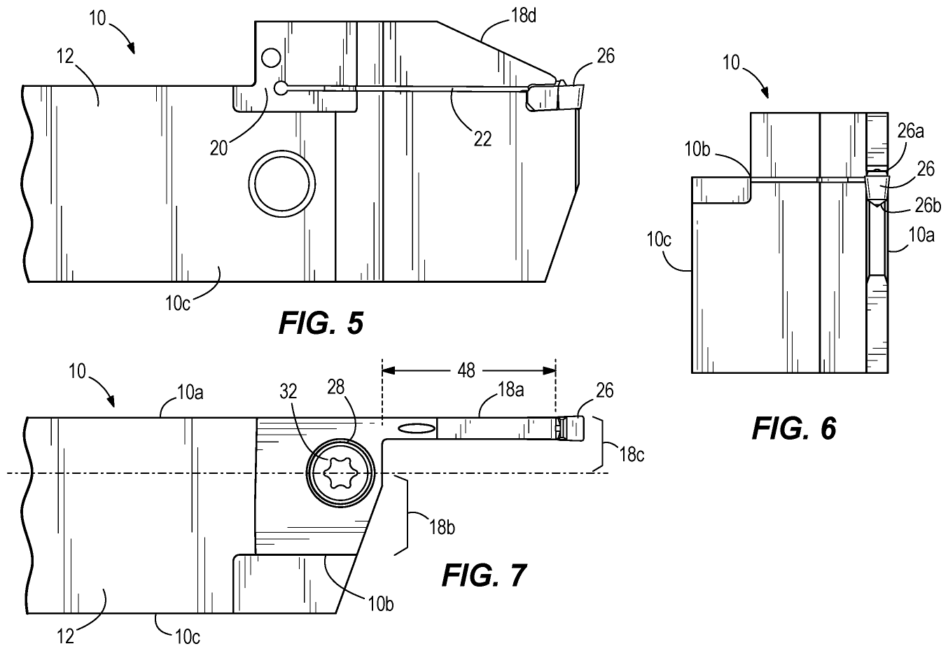

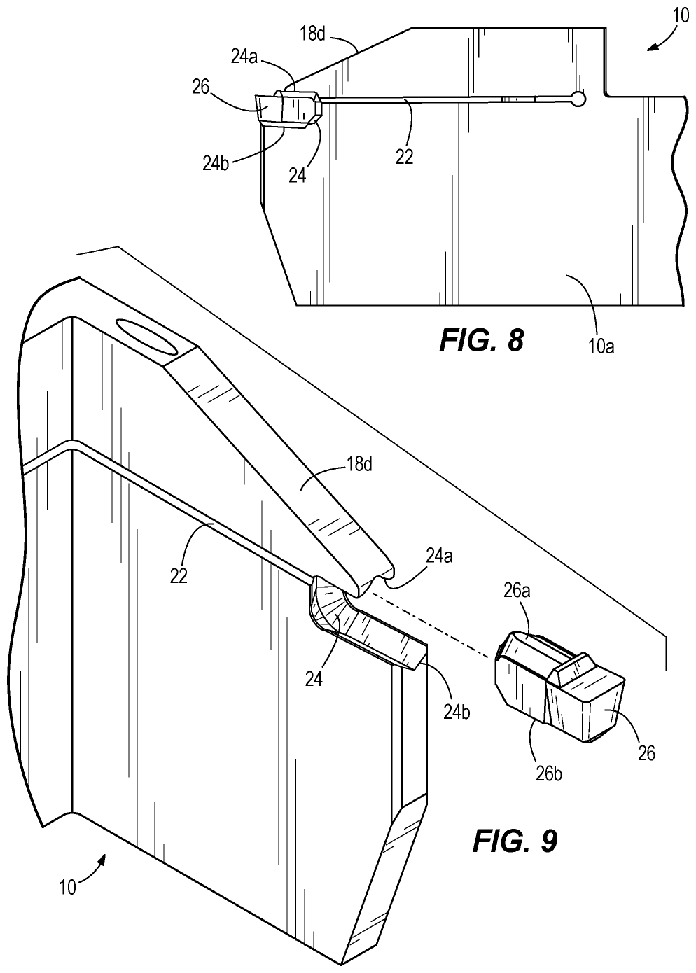

As shown in FIGS. 1-9 collectively, in one embodiment a grooving tool holder 10 comprises a shank 12, a lower portion 16, an upper portion 18, a web portion 20, a separating slit 22, a cutting insert receptacle 24, a cutting insert 26, a first fastener-mating hole 28, a second fastener-mating hole 30, and a fastener 32. The web portion 20 is disposed between the lower portion 16 and the upper portion 18. The separating slit 22 is disposed between the lower portion 16 and the upper portion 18. The separating slit 22 is disposed from the web portion 20 to the cutting insert receptacle 24. The upper portion 18 is pivotable relative to the lower portion 16 via the web portion 20.

The shank 12 extends longitudinally along the grooving tool holder 10. The shank 12 is configured to clamp the grooving tool holder 10 to a pocket P of a machine 34 using fasteners F.

The lower portion 16 comprises a first elongate member 16a extending longitudinally from the lower portion 16. The upper portion 18 comprises a second elongate member 18a extending longitudinally from the upper portion 18. The cutting insert receptacle 24 is disposed between the first elongate member 16a of the lower portion 16 and the second elongate member 18a of the upper portion 18. The cutting insert receptacle 24 comprises an upper clamping jaw 24a disposed in the second elongate member 18a of the upper portion 18 and a lower clamping jaw 24b disposed in the first elongate member 16a of the lower portion 16.

The cutting insert 26 is disposed between and against the upper clamping jaw 24a and the lower clamping jaw 24b. The upper clamping jaw 24a and an upper surface 26a of the cutting insert 26 each comprise a separate respective mating V-shape that mate against one another. Similarly, the lower clamping jaw 24b and a lower surface 26b of the cutting insert 26 each comprise a separate respective mating V-shape that mate against one another.

The first fastener-mating hole 28 is disposed in the upper portion 18. The second fastener-mating hole 30 is disposed in the lower portion 16 in concentric alignment with the first fastener-mating hole 28 around axis 31. The fastener 32 extends into the first and the second fastener-mating holes 28 and 30. The fastener 32 is threadedly attached to the second fastener-mating hole 30 causing the cutting insert 26 to be clamped between the upper clamping jaw 24a and the lower clamping jaw 24b.

The machine 34 may move the tool holder 10 linearly in direction 35 towards a workpiece W to cut a groove G in the workpiece W with the cutting insert 26, or in direction 37 away from the workpiece W to retract the cutting insert 26 from the workpiece W.

The upper clamping jaw 24a is configured to move towards the lower clamping jaw 24b in direction 36 as the fastener 32 is rotated in direction 38 within the first and second fastener-mating holes 28 and 30. As this happens, the upper clamping jaw 24a gradually clamps tighter against the upper surface 26a of the cutting insert 26 providing continuously increasing clamping of the cutting insert 26 between the upper clamping jaw 24a and the lower clamping jaw 24b.

The upper clamping jaw 24a is configured to move away from the lower clamping jaw 24b in direction 40 as the fastener 32 is rotated in direction 42 within the first and second fastener-mating holes 28 and 30. As this happens, the upper clamping jaw 24a gradually decreases the clamping against the upper surface 26a of the cutting insert 26 providing continuously decreasing clamping of the cutting insert 26 between the upper clamping jaw 24a and the lower clamping jaw 24b. In one embodiment, direction 40 may be clockwise and direction 42 may be counter-clockwise. In other embodiments, directions 40 and 42 may vary.

Axis 44 extends longitudinally along the grooving tool holder 10 through a center 46 of the first fastener-mating hole 28. Axis 44 intersects axis 31 perpendicularly. The upper portion 18 comprises first and second portions 18b and 18c disposed on opposite sides of the axis 44. The first and second portions 18b and 18c comprise different shapes and different sizes. The second portion 18c extends widthwise from axis 44 to a side-surface 10a of the grooving tool holder 10. The second elongate member 18a of the second portion 18c comprises a slope 18d which extends entirely linearly downward. The first portion 18b extends widthwise from axis 44 to a location 10b disposed inwardly from a side-surface 10c of the grooving tool holder 10.

The upper portion 18 comprises a total mass TM. The first portion 18b comprises a first mass FM. The second portion 18c comprises a second mass SM. The sum of the first mass FM and the second mass SM equals the total mass TM of the upper portion 18. In one embodiment, the first mass FM and the second mass SM are within +−20% of one another. In another embodiment, the first mass FM and the second mass SM are within +−15% of one another. In still another embodiment, the first mass FM and the second mass SM are within +−10% of one another. In yet another embodiment, the first mass FM and the second mass SM are within +−5% of one another. In still another embodiment, the first mass FM and the second mass SM are idential.

It has been discovered that it is critical and unexpected to have the first mass FM and the second mass SM be within +−20% of one another, within +−15% of one another, within +−10% of one another, within +−5% of one another, or be identical. This has been unexpectedly discovered to: (1) improve clamping strength on the cutting insert 26 applied by the upper and lower clamping jaws 24a and 24b of the grooving tool holder 10, particularly for grooving tool holders 10 having longer-length 48 second elongate members 18a which reduces the likelihood of the cutting insert 26 from coming out of the cutting insert receptacle 24; (2) redistribute pressure between the upper clamping jaw 24a and the upper surface 26a of the cutting insert 26 and between the lower clamping jaw 24b and the lower surface 26b of the cutting insert 26 resulting in increased positive clamping force being placed on the cutting insert 26; and (3) optimize the clamping force placed on the cutting insert 26 by the upper and lower clamping jaws 24a and 24b to obtain increased reaction force 50 of the upper surface 26a of the cutting insert 26 against the upper clamping jaw 24a. These unexpected benefits are obtained without having to alter the screw tightening torque placed on the fastener 32 extending between the first and the second fastener-mating holes 28 and 30 and threadedly mated to the second fastener-mating hole 30.

In other embodiments, one or more of the components of the grooving tool holder 10 of FIGS. 1-9 may not be present or may vary in type, form, configuration, shape, size, placement, location, or in other ways.

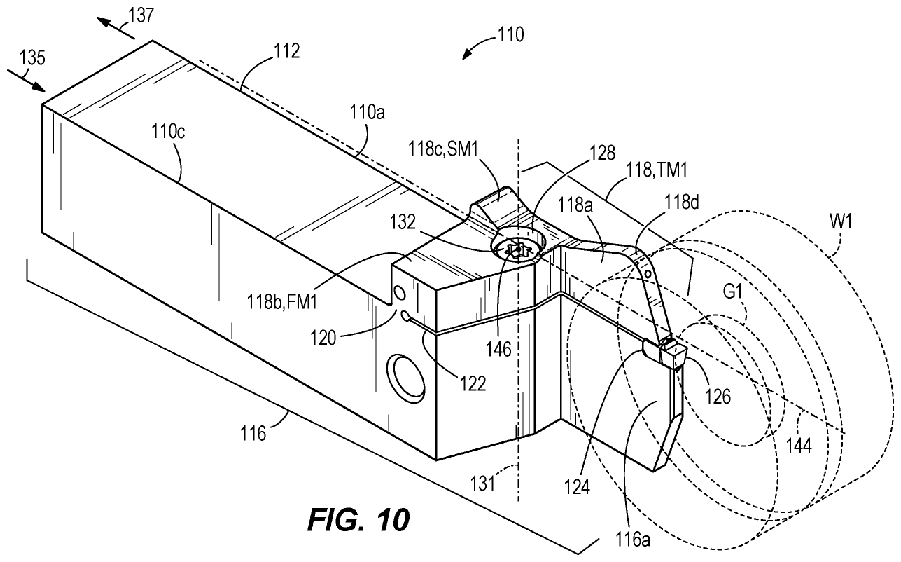

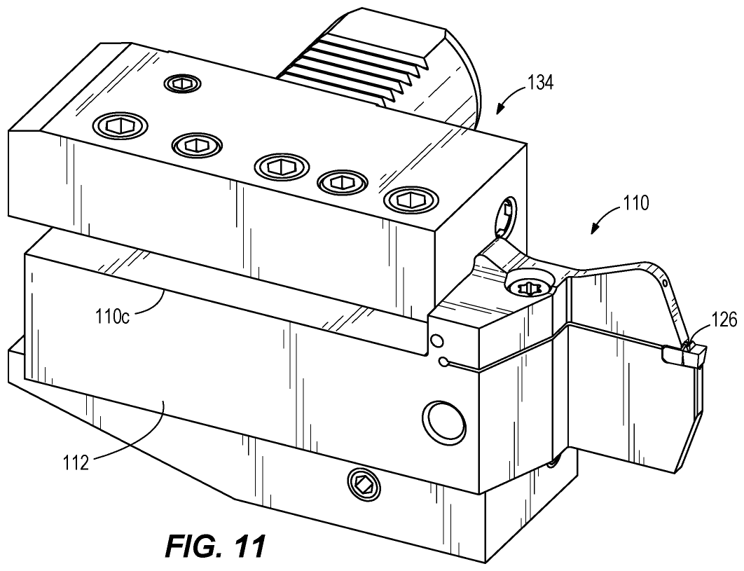

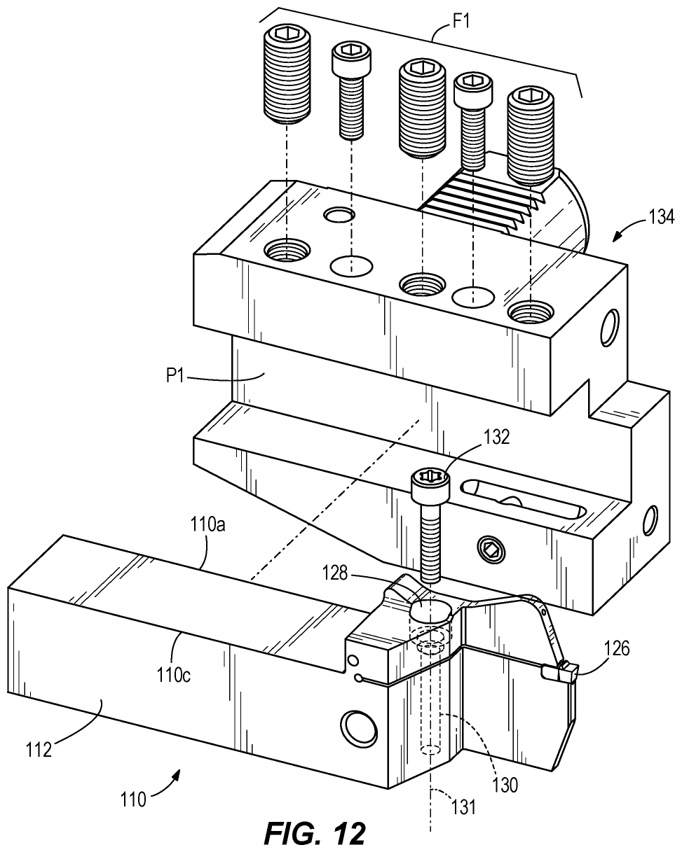

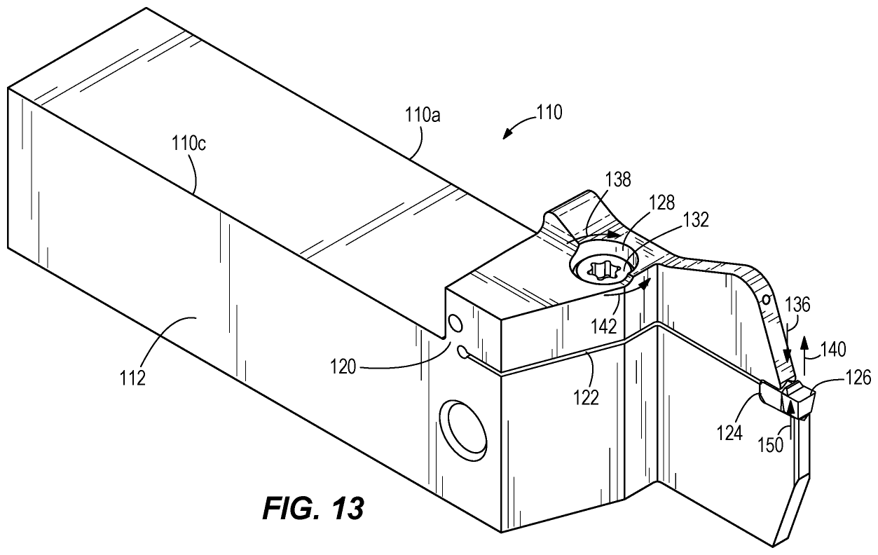

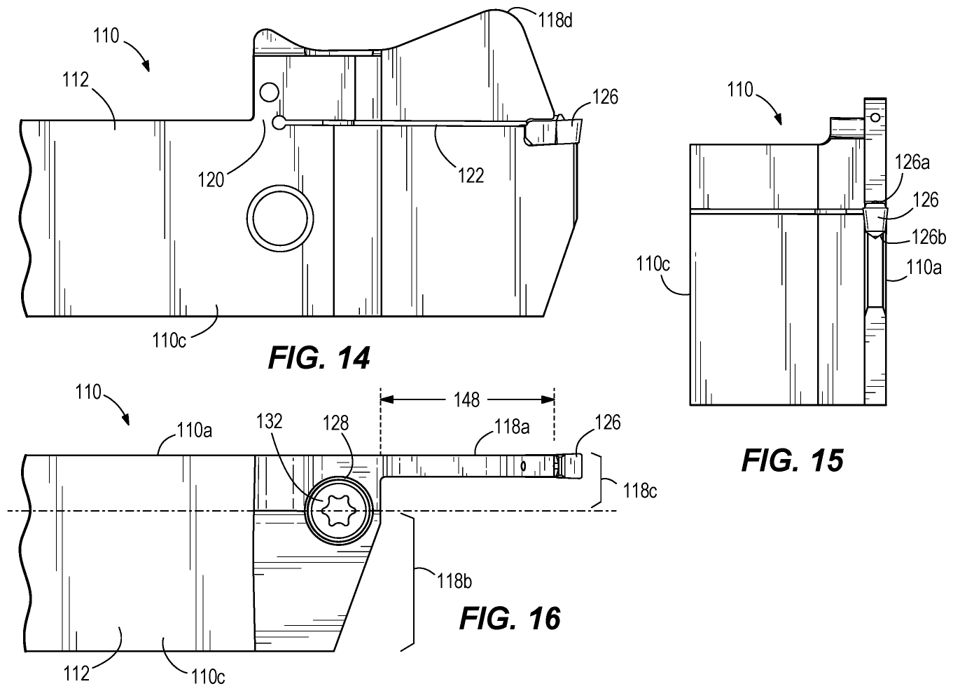

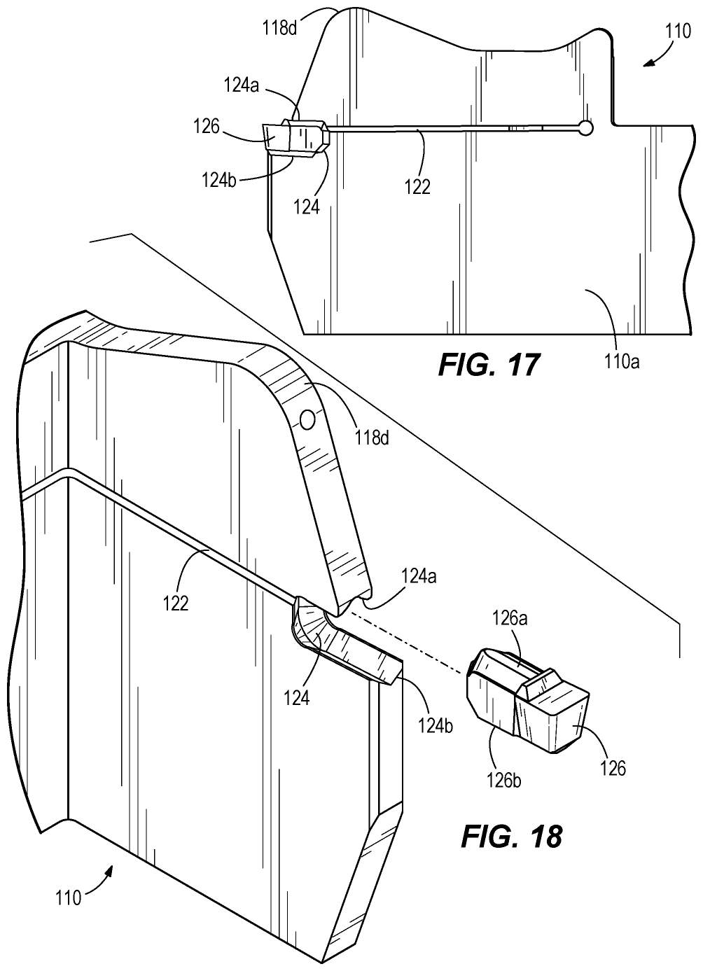

As shown in FIGS. 10-18 collectively, in another embodiment a grooving tool holder 100 comprises a shank 112, a lower portion 116, an upper portion 118, a web portion 120, a separating slit 122, a cutting insert receptacle 124, a cutting insert 126, a first fastener-mating hole 128, a second fastener-mating hole 130, and a fastener 132. The web portion 120 is disposed between the lower portion 116 and the upper portion 118. The separating slit 122 is disposed between the lower portion 116 and the upper portion 118. The separating slit 122 is disposed from the web portion 120 to the cutting insert receptacle 124. The upper portion 118 is pivotable relative to the lower portion 116 via the web portion 120.

The shank 112 extends longitudinally along the grooving tool holder 110. The shank 112 is configured to clamp the grooving tool holder 110 to a pocket P1 of a machine 134 using fasteners F1.

The lower portion 116 comprises a first elongate member 116a extending longitudinally from the lower portion 116. The upper portion 118 comprises a second elongate member 118a extending longitudinally from the upper portion 118. The cutting insert receptacle 124 is disposed between the first elongate member 116a of the lower portion 116 and the second elongate member 118a of the upper portion 118. The cutting insert receptacle 124 comprises an upper clamping jaw 124a disposed in the second elongate member 118a of the upper portion 118 and a lower clamping jaw 124b disposed in the first elongate member 116a of the lower portion 116.

The cutting insert 126 is disposed between and against the upper clamping jaw 124a and the lower clamping jaw 124b. The upper clamping jaw 124a and an upper surface 126a of the cutting insert 126 each comprise a separate respective mating V-shape that mate against one another. Similarly, the lower clamping jaw 124b and a lower surface 126b of the cutting insert 126 each comprise a separate respective mating V-shape that mate against one another.

The first fastener-mating hole 128 is disposed in the upper portion 118. The second fastener-mating hole 130 is disposed in the lower portion 116 in concentric alignment with the first fastener-mating hole 128 around axis 131. The fastener 132 extends into the first and the second fastener-mating holes 128 and 130. The fastener 132 is threadedly attached to the second fastener-mating hole 130 causing the cutting insert 126 to be clamped between the upper clamping jaw 124a and the lower clamping jaw 124b.

The machine 134 may move the tool holder 110 linearly in direction 135 towards a workpiece W1 to cut a groove G1 in the workpiece W1 with the cutting insert 126, or in direction 137 away from the workpiece W1 to retract the cutting insert 126 from the workpiece W1.

The upper clamping jaw 124a is configured to move towards the lower clamping jaw 124b in direction 136 as the fastener 132 is rotated in direction 138 within the first and second fastener-mating holes 128 and 130. As this happens, the upper clamping jaw 124a gradually clamps tighter against the upper surface 126a of the cutting insert 126 providing continuously increasing clamping of the cutting insert 126 between the upper clamping jaw 124a and the lower clamping jaw 124b.

The upper clamping jaw 124a is configured to move away from the lower clamping jaw 124b in direction 140 as the fastener 132 is rotated in direction 142 within the first and second fastener-mating holes 128 and 130. As this happens, the upper clamping jaw 124a gradually decreases the clamping against the upper surface 126a of the cutting insert 126 providing continuously decreasing clamping of the cutting insert 126 between the upper clamping jaw 124a and the lower clamping jaw 124b. In one embodiment, direction 140 may be clockwise and direction 142 may be counter-clockwise. In other embodiments, directions 140 and 142 may vary.

Axis 144 extends longitudinally along the grooving tool holder 110 through a center 146 of the first fastener-mating hole 128. Axis 144 intersects axis 131 perpendicularly. The upper portion 118 comprises first and second portions 118b and 118c disposed on opposite sides of axis 144. The first and second portions 118b and 118c comprise different shapes and different sizes. The second portion 118c extends widthwise from axis 144 to a side-surface 110a of the grooving tool holder 110. The second elongate member 118a of the second portion 118c comprises a slope 118d which extends upward and then curves downward. The first portion 118b extends widthwise from axis 144 to a side-surface 110c of the grooving tool holder 110.

The upper portion 118 comprises a total mass TM1. The first portion 118b comprises a first mass FM1. The second portion 118c comprises a second mass SM1. The sum of the first mass FM1 and the second mass SM1 equals the total mass TM1 of the upper portion 118. In one embodiment, the first mass FM1 and the second mass SM1 are within +−20% of one another. In another embodiment, the first mass FM1 and the second mass SM1 are within +−15% of one another. In still another embodiment, the first mass FM1 and the second mass SM1 are within +−10% of one another. In yet another embodiment, the first mass FM1 and the second mass SM1 are within +−5% of one another. In still another embodiment, the first mass FM1 and the second mass SM1 are identical.

It has been discovered that it is critical and unexpected to have the first mass FM1 and the second mass SM1 be within +−20% of one another, within +−15% of one another, within +−10% of one another, within +-5% of one another, or be identical. This has been unexpectedly discovered to: (1) improve clamping strength on the cutting insert 126 applied by the upper and lower clamping jaws 124a and 124b of the grooving tool holder 110, particularly for grooving tool holders 110 having longer-length 148 second elongate members 118a which reduces the likelihood of the cutting insert 126 from coming out of the cutting insert receptacle 124; (2) redistribute pressure between the upper clamping jaw 124a and the upper surface 126a of the cutting insert 126 and between the lower clamping jaw 124b and the lower surface 126b of the cutting insert 126 resulting in increased positive clamping force being placed on the cutting insert 126; and (3) optimize the clamping force placed on the cutting insert 126 by the upper and lower clamping jaws 124a and 124b to obtain increased reaction force 150 of the upper surface 126a of the cutting insert 126 against the upper clamping jaw 124a. These unexpected benefits are obtained without having to alter the screw tightening torque placed on the fastener 132 extending between the first and the second fastener-mating holes 128 and 130 and threadedly mated to the second fastener-mating hole 130.

In still other embodiments, the sizes and shapes of the first portions 18b and 118b and second portions 18c and 118c may vary further as long as the first mass FM and FM1 of the first portions 18b and 118b and the second mass SM and SM1 of the second portions 18c and 118c are within +−20% of one another, within +−15% of one another, within +−10% of one another, within +−5% of one another, or be identical.

In other embodiments, one or more of the components of the grooving tool holder 110 of FIGS. 10-18 may not be present or may vary in type, form, configuration, shape, size, placement, location, or in other ways.

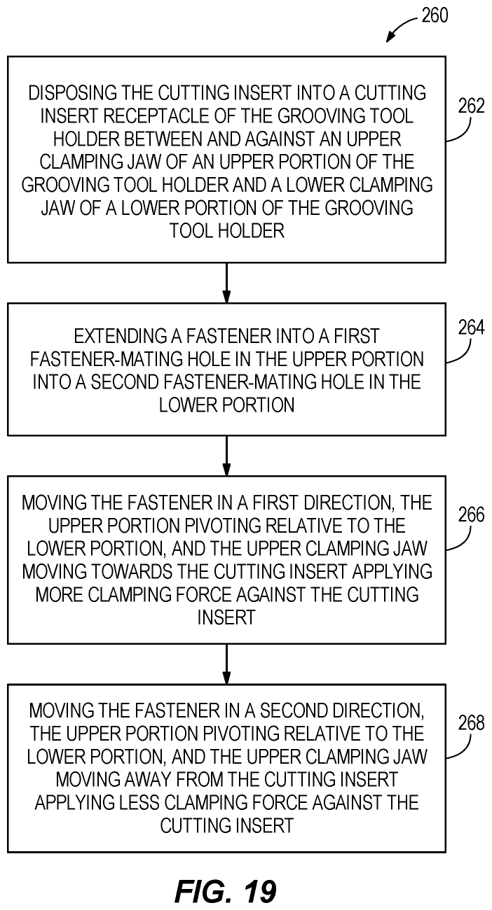

As shown in FIG. 19, one embodiment of a method 260 of attaching a cutting insert to a grooving tool holder is disclosed. The method 260 may utilize any of the grooving tool holders disclosed herein. In other embodiments, the method 260 may utilize varying grooving tool holders.

Step 262 comprises disposing the cutting insert into a cutting insert receptacle of the grooving tool holder between and against an upper clamping jaw of an upper portion of the grooving tool holder and a lower clamping jaw of a lower portion of the grooving tool holder. The upper portion comprises first and second portions disposed on opposite sides of a first axis extending longitudinally along the grooving tool holder through a center of the first fastener-mating hole. The first and second portions comprise different shapes or different sizes. The upper portion comprises a total mass. The first portion comprises a first mass. The second portion comprises a second mass. A sum of the first mass and the second mass equals the total mass of the upper portion. The first mass and the second mass are within +−20% of one another.

Step 264 comprises extending a fastener into a first fastener-mating hole in the upper portion into a second fastener-mating hole in the lower portion. Step 266 comprises moving the fastener in a first direction, the upper portion pivoting relative to the lower portion, and the upper clamping jaw moving towards the cutting insert applying more clamping force against the cutting insert. Step 268 comprises the fastener moving in a second direction, the upper portion pivoting relative to the lower portion, and the upper clamping jaw moving away from the cutting insert applying less clamping force against the cutting insert.

The upper portion may pivot relative to the lower portion via a web portion disposed between the lower portion and the upper portion. A separating slit may be disposed between the lower portion and the upper portion. The separating slit may be disposed from the web portion to the cutting insert receptacle.

The first and second fastener-mating holes may be disposed concentrically around a second axis.

The first and second axis may intersect perpendicularly.

The first mass and the second mass may be within +−15% of one another.

The first mass and the second mass may be within +−10% of one another.

The first mass and the second mass may be within +−5% of one another.

The first mass and the second mass may be identical.

The lower portion may comprise a first elongate member extending longitudinally from the lower portion. The upper portion may comprise a second elongate member extending longitudinally from the upper portion. The cutting insert receptacle may be disposed between the first and second elongate members. The disposing the cutting insert into the cutting insert receptacle of the grooving tool holder may comprise disposing the cutting insert into the cutting insert receptacle between the first and second elongate members.

In other embodiments, one or more steps of the method 260 may not be followed, may be modified in substance or order, or one or more additional steps may be added. In still other embodiments, the method 260 may further vary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter. While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

### REFERENCE NUMERALS

grooving tool holder 10
side-surface 10a
location 10b
side-surface 10c
shank 12
lower portion 16
first elongate member 16a
upper portion 18
second elongate member 18a
first portion 18b
second portion 18c
slope 18d
web portion 20
separating slit 22
cutting insert receptacle 24
upper clamping jaw 24a
lower clamping jaw 24b
cutting insert 26
upper surface 26a
lower surface 26b
first fastener-mating hole 28
second fastener-mating hole 30
axis 31
fastener 32
machine 34
direction 35
direction 36
direction 37
direction 38
direction 40
direction 42
axis 44
center 46
longer-length 48
reaction force 50
fasteners F
groove G
pocket P
workpiece W
first mass FM
second mass SM
total mass TM
grooving tool holder 110
side-surface 110a
side-surface 110c
shank 112
lower portion 116
first elongate member 116a
upper portion 118
second elongate member 118a
first portion 118b
second portion 118c
slope 118d
web portion 120
separating slit 122
cutting insert receptacle 124
upper clamping jaw 124a
lower clamping jaw 124b
cutting insert 126
upper surface 126a
lower surface 126b
first fastener-mating hole 128
second fastener-mating hole 130
axis 131
fastener 132
machine 134
direction 135
direction 136
direction 137
direction 138
direction 140
direction 142
axis 144
center 146
longer-length 148
reaction force 150
fasteners F1
groove G1
pocket P1
workpiece W1
first mass FM1
second mass SM1
total mass TM1
method 260
step 262
step 264
step 266
step 268

1. A grooving tool holder (10 and 110) comprising:
a lower portion (16 and 116);
an upper portion (18 and 118) pivotable relative to the lower portion (16 and 116);
a cutting insert receptacle (24 and 124) disposed between the lower portion (16 and 116) and the upper portion (18 and 118), the cutting insert receptacle (24 and 124) comprising an upper clamping jaw (24a and 124a) disposed in the upper portion (18 and 118) and a lower clamping jaw (24b and 124b) disposed in the lower portion (16 and 116);
a first fastener-mating hole (28 and 128) disposed in the upper portion (18 and 118);
a second fastener-mating hole (30 and 130) disposed in the lower portion (16 and 116) in alignment with the first fastener-mating hole (28 and 128);
a first axis (44 and 144) extending longitudinally along the grooving tool holder (10 and 110) through a center (46 and 146) of the first fastener-mating hole (28 and 128); and
the upper portion (18 and 118) comprising first and second portions (18b, 118b, 18c, 118c) disposed on opposite sides of the first axis (44 and 144), the first and second portions (18b, 118b, 18c, 118c) comprising different shapes or different sizes, the upper portion (18 and 118) comprising a total mass (TM and TM1), the first portion (18b and 118b) comprising a first mass (FM and FM1), the second portion (18c and 118c) comprising a second mass (SM and SM1), a sum of the first mass (FM and FM1) and the second mass (SM and SM1) equaling the total mass (TM and TM1) of the upper portion (18 and 118), the first mass (FM and FM1) and the second mass (SM and SM1) being within +−20% of one another.

2. The grooving tool holder (10 and 110) of claim 1 further comprising a web portion (20 and 120) disposed between the lower portion (16 and 116) and the upper portion (18 and 118), the upper portion (18 and 118) pivotable relative to the lower portion (16 and 116) via the web portion (20 and 120).

3. The grooving tool holder (10 and 110) of claim 2 further comprising a separating slit (22 and 122) disposed between the lower portion (16 and 116) and the upper portion (18 and 118), the separating slit (22 and 122) disposed from the web portion (20 and 120) to the cutting insert receptacle (24 and 124).

4. The grooving tool holder (10 and 110) of claim 1 further comprising a fastener (32 and 132) extending into the first and second fastener-mating holes (28, 128, 30, 130).

5. The grooving tool holder (10 and 110) of claim 4 wherein the fastener (32 and 132) is threadedly attached to the second fastener-mating hole (30 and 130).

6. The grooving tool holder (10 and 110) of claim 4 wherein the upper clamping jaw (24a and 124a) is configured to move towards the lower clamping jaw (24b and 124b) as the fastener (32 and 132) is rotated in a first direction (38 and 138) within the first and second fastener-mating holes (28, 128, 30, 130), and the upper clamping jaw (24a and 124a) is configured to move away from the lower clamping jaw (24b and 124b) as the fastener (32 and 132) is rotated in a second direction (42 and 142) within the first and second fastener-mating holes (28, 128, 30, 130).

7. The grooving tool holder (10 and 110) of claim 1 further comprising a cutting insert (26 and 126) disposed between and against the upper clamping jaw (24a and 124a) and the lower clamping jaw (24b and 124b).

8. The grooving tool holder (10 and 110) of claim 7 wherein the upper clamping jaw (24a and 124a) and an upper surface (26a and 126a) of the cutting insert (26 and 126) each comprise a separate respective mating V-shape.

9. The grooving tool holder (10 and 110) of claim 1 further comprising a shank (12 and 112) extending longitudinally along the grooving tool holder (10 and 110), the shank (10 and 110) configured to clamp the grooving tool holder (10 and 110) to a machine (34 and 134).

10. The grooving tool holder (10 and 110) of claim 1 wherein the first mass (FM and FM1) and the second mass (SM and SM1) are within +−10% of one another.

11. The grooving tool holder (10 and 110) of claim 1 wherein the first mass (FM and FM1) and the second mass (SM and SM1) are within +−5% of one another.

12. The grooving tool holder (10 and 110) of claim 1 wherein the lower portion (16 and 116) comprises a first elongate member (16 and 116a) extending longitudinally from the lower portion (16 and 116), the upper portion (18 and 118) comprises a second elongate member (18a and 118a) extending longitudinally from the upper portion (18 and 118), and the cutting insert receptacle (24 and 124) is disposed between the first and second elongate members (16, 116a, 18a, 118a).

13. A grooving tool holder (10 and 110) comprising:
a lower portion (16 and 116);
an upper portion (18 and 118);
a web portion (20 and 120) disposed between the lower portion (16 and 116) and the upper portion (18 and 118);
a cutting insert receptacle (24 and 124) disposed between the lower portion (16 and 116) and the upper portion (18 and 118), the cutting insert receptacle (24 and 124) comprising an upper clamping jaw (24a and 124a) disposed in the upper portion (18 and 118) and a lower clamping jaw (24b and 124b) disposed in the lower portion (16 and 116);
a separating slit (22 and 122) disposed from the web portion (20 and 120) to the cutting insert receptacle (24 and 124), the upper portion (18 and 118) being pivotable relative to the lower portion (16 and 116) via the web portion (20 and 120);
a first fastener-mating hole (28 and 128) disposed in the upper portion (18 and 118);
a second fastener-mating hole (30 and 130) disposed in the lower portion (16 and 116);
a first axis (44 and 144) extending longitudinally along the grooving tool holder (10 and 110) through a center (46 and 146) of the first fastener-mating hole (28 and 128), the first and second fastener-mating holes (28, 128, 30, 130) concentrically aligned around a second axis (31 and 131), the first and second axis (44, 144, 31, 131) intersecting perpendicularly; and
the upper portion (18 and 118) comprising first and second portions (18b, 118b, 18c, 118c) disposed on opposite sides of the first axis (44 and 144), the first and second portions (18b, 118b, 18c, 118c) comprising different shapes or different sizes, the upper portion (18 and 118) comprising a total mass (TM and TM1), the first portion (18b and 118b) comprising a first mass (FM and FM1), the second portion (18c and 118c) comprising a second mass (SM and SM1), a sum of the first mass (FM and FM1) and the second mass (SM and SM1) equaling the total mass (TM and TM1) of the upper portion (18 and 118), the first mass (FM and FM1) and the second mass (SM and SM1) being within +−20% of one another.

14. A method (260) of attaching a cutting insert (26 and 126) to a grooving tool holder (10 and 110) comprising:
disposing the cutting insert (26 and 126) into a cutting insert receptacle (24 and 124) of the grooving tool holder (10 and 110) between and against an upper clamping jaw (24a and 124a) of an upper portion (18 and 118) of the grooving tool holder (10 and 110) and a lower clamping jaw (24b and 124b) of a lower portion (16 and 116) of the grooving tool holder (10 and 110), the upper portion (18 and 118) comprising first and second portions (18b, 118b, 18c, 118c) disposed on opposite sides of a first axis (44 and 144) extending longitudinally along the grooving tool holder (10 and 110) through a center (46 and 146) of the first fastener-mating hole (28 and 128), the first and second portions (18b, 118b, 18c, 118c) comprising different shapes or different sizes, the upper portion (18 and 118) comprising a total mass (TM and TM1), the first portion (18b and 118b) comprising a first mass (FM and FM1), the second portion (18c and 118c) comprising a second mass (SM and SM1), a sum of the first mass (FM and FM1) and the second mass (SM and SM1) equaling the total mass (TM and TM1) of the upper portion (18 and 118), and the first mass (FM and FM1) and the second mass (SM and SM1) being within +−20% of one another;
extending a fastener (32 and 132) into a first fastener-mating hole (28 and 128) in the upper portion (18 and 118) into a second fastener-mating hole (30 and 130) in the lower portion (16 and 116);
moving the fastener (32 and 132) in a first direction (38 and 138), the upper portion (18 and 118) pivoting relative to the lower portion (16 and 116), and the upper clamping jaw (24a and 124a) moving towards the cutting insert (26 and 126) applying more clamping force against the cutting insert (26 and 126); and
moving the fastener (32 and 132) in a second direction (42 and 142), the upper portion (18 and 118) pivoting relative to the lower portion (16 and 116), and the upper clamping jaw (24a and 124a) moving away from the cutting insert (26 and 126) applying less clamping force against the cutting insert (26 and 126).

15. The method of claim 14 wherein the upper portion (18 and 118) pivoting relative to the lower portion (16 and 116) comprises the upper portion (18 and 118) pivoting relative to the lower portion (16 and 116) via a web portion (20 and 120) disposed between the lower portion (16 and 116) and the upper portion (18 and 118), wherein a separating slit (22 and 122) is disposed between the lower portion (16 and 116) and the upper portion (18 and 118), the separating slit (22 and 122) disposed from the web portion (20 and 120) to the cutting insert receptacle (24 and 124).

16. The method of claim 14 wherein the first and second fastener-mating holes (28, 128, 30, 130) are disposed concentrically around a second axis (31 and 131).

17. The method of claim 16 wherein the first and second axis (44, 144, 31, 131) intersect perpendicularly.

18. The method of claim 14 wherein the first mass (FM and FM1) and the second mass (SM and SM1) are within +−10% of one another.

19. The method of claim 14 wherein the first mass (FM and FM1) and the second mass (SM and SM1) are within +−5% of one another.

20. The method of claim 14 wherein the lower portion (16 and 116) comprises a first elongate member (16 and 116a) extending longitudinally from the lower portion (16 and 116), the upper portion (18 and 118) comprises a second elongate member (18a and 118a) extending longitudinally from the upper portion (18 and 118), and the disposing the cutting insert (26 and 126) into the cutting insert receptacle (24 and 124) of the grooving tool holder (10 and 110) comprises disposing the cutting insert (26 and 126) into the cutting insert receptacle (24 and 124) between the first and second elongate members (16, 116a, 18a, 118a).
